(19) United States
(12) Patent Application Publication
(10) Pub. No.: US 2007/0180203 A1
(43) Pub. Date: Aug. 2, 2007

(54) Optimizing system performance in flexible interleaving memory mode

(76) Inventors: Madhusudhan Ramgarajan, Round Rock, TX (US); Allen C. Wynn, Round Rock, TX (US)

Correspondence Address: HAMILTON & TERRILE, LLP, P.O. BOX 203518, AUSTIN, TX, 78720, US

(21) Appl. No.: 11/344,647

(22) Filed: Feb. 1, 2006

(51) Int. Cl. G06F 13/00

(52) U.S. Cl. 711/157

(57) ABSTRACT

A method for optimizing performance of memory in an information handling system which includes determining whether memory within the information handing system is being accessed in a flexible interleaving memory mode of operation, when the memory is being accessed in the flexible interleaving memory mode of operation, identifying which of the memory is configured as interleaved memory and which of the memory is configured as non-interleaved memory, and configuring the memory such that the interleaved memory is accessed prior to the non-interleaved memory being accessed is disclosed.

### BACKGROUND OF THE INVENTION

1. Field of the Invention

The present invention relates to the field of optimizing system performance in flexible interleaving memory mode.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Known information handling systems may include a flexible memory interleaving mode of operation that in one instantiation is referred to as a flex mode. In a flexible memory interleaving mode of operation mode, some of memory of the information handling system can be interleaved and other portions of memory of the information handling system can be non-interleaved. When memory is interleaved, separate memory banks are used for odd and even addresses so that a next byte of memory can be accessed while a current byte is being refreshed. When memory is non-interleaved, sequential portions of the same memory back are used for writing odd and even addresses.

Using a flexible memory interleaving mode of operation in which some of the memory is interleaved and some of the memory is non-interleaved, can lead to performance issues within the information handling system if the operating system uses the non-interleaved memory more than the interleaved memory.

### SUMMARY OF THE INVENTION

In accordance with the present invention, a method of using flex mode which optimizes the use of interleaved memory before any non-interleaved memory is used is disclosed.

More specifically, In one embodiment, the invention relates to a method for optimizing performance of memory in an information handling system which includes determining whether memory within the information handing system is being accessed in a flexible interleaving memory mode of operation, when the memory is being accessed in the flexible interleaving memory mode of operation, identifying which of the memory is configured as interleaved memory and which of the memory is configured as non-interleaved memory, and configuring the memory such that the interleaved memory is accessed prior to the non-interleaved memory being accessed.

In another embodiment, the invention relates to an apparatus for optimizing performance of memory in an information handling system which includes means for determining whether memory within the information handing system is being accessed in a flexible interleaving memory mode of operation, means for identifying which of the memory is configured as interleaved memory and which of the memory is configured as non-interleaved memory when the memory is being accessed in the flexible interleaving memory mode of operation, and means for configuring the memory such that the interleaved memory is accessed prior to the non-interleaved memory being accessed.

In another embodiment, the invention relates to an information handling system which includes a processor, memory coupled to the processor and flexible interleaving memory mode optimization system. The flexible interleaving memory mode optimization system determines whether memory within the information handing system is being accessed in a flexible interleaving memory mode of operation, identifies which of the memory is configured as interleaved memory and which of the memory is configured as non-interleaved memory when the memory is being accessed in the flexible interleaving memory mode of operation, and configures the memory such that the interleaved memory is accessed prior to the non-interleaved memory being accessed.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an information handling system.

FIG. 2 shows a block diagram of memory configured with optimized flex mode addressing.

FIG. 3 shows a block diagram of another example of memory configured with optimized flex mode addressing.

FIG. 4 shows a block diagram of another example of memory configured with optimized flex mode addressing.

### DETAILED DESCRIPTION

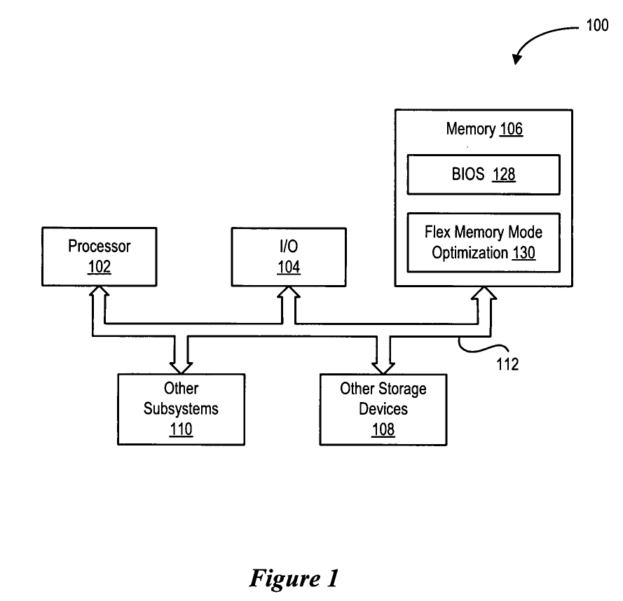

Referring briefly to FIG. 1, a system block diagram of an information handling system 100 is shown. The information handling system 100 includes a processor 102, input/output (I/O) devices 104, such as a display, a keyboard, a mouse, and associated controllers, memory 106 including volatile storage such as random access memory (RAM) and non-volatile storage such as a hard disk drive, other storage devices 108, such as a floppy disk and drive and other memory devices, and various other subsystems 110, all interconnected via one or more buses 112. The memory 106 also includes associated memory controllers for the volatile and non-volatile storage. The information handling system 100 also includes a basic input output system (BIOS) 128 as well as a flexible interleaving memory mode optimization system 130 stored on the non-volatile storage device 106 and executed by the processor 102.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

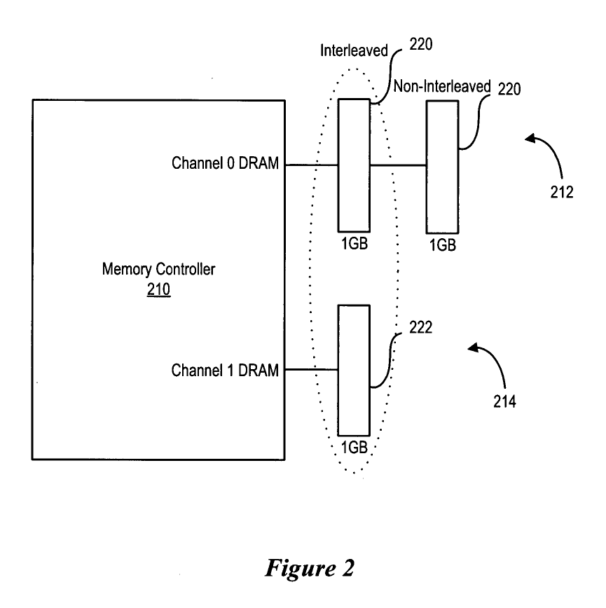

Referring to FIG. 2, a block diagram of memory configured with optimized flex mode addressing is shown. More specifically, the memory 106 includes a memory controller 210 as well as a plurality of banks of memory 212, 214. The banks of memory are not balanced, i.e., one of the banks 212 includes more memory than the other bank 214. For example, one of the banks of memory 212 might have two memory modules such as single in-line memory modules (SIMMs) or dual in-line memory modules (DIMMs) installed, while the other bank of memory 214 has only a single memory module installed. Alternately, for example, one of the banks of memory might have a faulty memory module, thus causing the memory module to appear to not be installed. This is an arrangement which typically would preclude the use of interleaved memory. For example, in one embodiment, channel 0 of the memory controller 210 is coupled to a bank of memory having two 1 GB memory modules 220. Channel 1 of the memory controller is coupled to a bank of memory having one 1GB memory module 222.

By using the flexible interleaving memory mode optimization system 130, the memory controller 210 is configured such portions of the banks of memory 212, 214 that are balanced may be interleaved, while the remainder of the bank of memory 212 that does not have corresponding memory in the other bank is non-interleaved. More specifically, in the described embodiment, in the system memory map, 0-2 GB are interleaved and 2-3 GB are non-interleaved. To ensure that the operating system gives priority to the interleaved memory, the BIOS sets up an advanced configuration and power interface (ACPI) static resource affinity table (SRAT) to describe memory from 0-2 GB as being “close” to the processor 102 and sets up ACPI SRAT tables to describe memory from 2-3 GB as being far away from the processor 102. By identifying the interleaved memory as closes memory, the operating system gives priority to this memory when writing to memory, thus improving performance. The BIOS 128 controls which memory is interleaved and which memory is non-interleaved and configures the memory controller 210 accordingly.

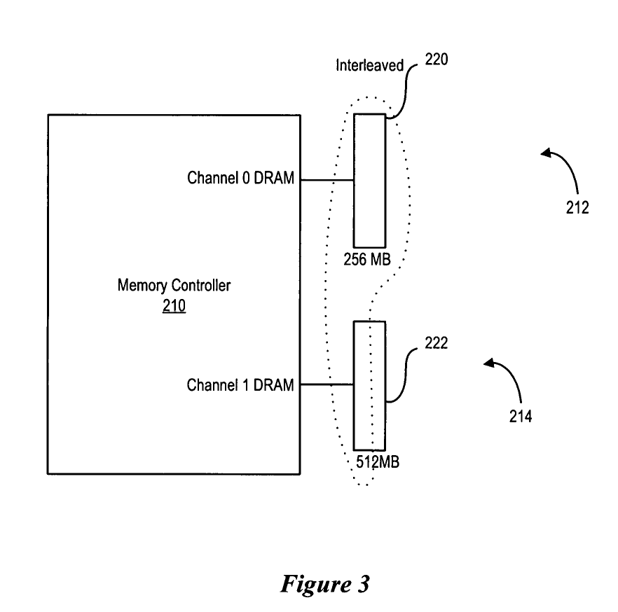

Referring to FIG. 3, a block diagram of another example of memory configured with optimized flex mode addressing is shown. More specifically, the memory 106 includes a memory controller 210 as well as a plurality of banks of memory 212, 214. The banks of memory are not balanced, i.e., one of the banks 212 includes more memory than the other bank 214. In this example, one of the banks of memory 212 might have a smaller memory module installed (e.g., a 256 MB memory module), while the other bank of memory 214 has a larger memory module installed (e.g., a 512 MB memory module). Alternately, a portion of one of the memory modules might be faulty, thus causing it to appear to be smaller. This is an arrangement which typically would preclude the use of interleaved memory.

By using the flexible interleaving memory mode optimization system 130, the memory controller 210 is configured such portions of the banks of memory 212, 214 that are balanced may be interleaved, while the remainder of the bank of memory 214 that does not have corresponding memory in the other bank is non-interleaved. More specifically, in the described embodiment, in the system memory map, 0-511 MB are interleaved and 512-767MB are non-interleaved. To ensure that the operating system gives priority to the interleaved memory, the BIOS sets up an advanced configuration and power interface (ACPI) static resource affinity table (SRAT) to describe memory from 0-511 as being “close” to the processor 102 and sets up ACPI SRAT tables to describe memory from 512-767 BB as being far away from the processor 102. By identifying the interleaved memory as closes memory, the operating system gives priority to this memory when writing to memory, thus improving performance. The BIOS 128 controls which memory is interleaved and which memory is non-interleaved and configures the memory controller 210 accordingly.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script,batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

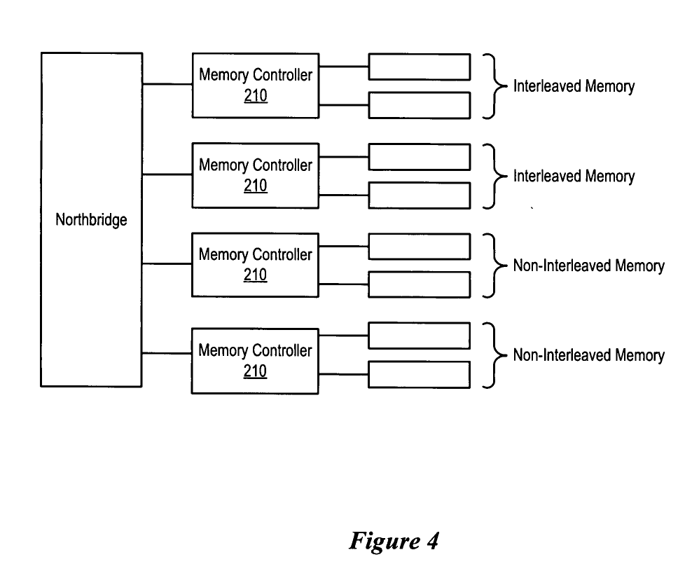

Also, while examples of the optimization are shown with two banks of memory, it will be appreciated that an information handling system having more than two banks of memory may also use the method for optimizing system performance in flexible interleaving memory mode. For example, FIG. 4 shows a block diagram of a plurality of memory controllers coupled to a northbridge type controller. Some of the memory controllers control memory that is interleaved, while other memory controllers control memory that is non-interleaved. The flexible interleaving memory mode optimization system enables the operating system to access the interleaved memory before accessing the non-interleaved memory.

Consequently, the invention is intended to be limited only by the spirit and scope of the appended claims, giving full cognizance to equivalents in all respects.

What is claimed is:

1. A method for optimizing performance of memory in an information handling system comprising:
determining whether memory within the information handing system is being accessed in a flexible interleaving memory mode of operation;
when the memory is being accessed in the flexible interleaving memory mode of operation, identifying which of the memory is configured as interleaved memory and which of the memory is configured as non-interleaved memory; and,
configuring the memory such that the interleaved memory is accessed prior to the non-interleaved memory being accessed.

2. The method of claim 1 wherein:
the configuring the memory such that the interleaved memory is accessed prior to the non-interleaved memory includes accessing a static resource affinity table.

3. The method of claim 1 wherein:
the configuring the memory includes identifying the interleaved memory as closer to a processor and non-interleaved memory as far away from the processor.

4. The method of claim 3 wherein:
an operating system accesses the memory that is closer to the processor before accessing the memory that is far away from the processor.

5. The method of claim 3 wherein:
the identifying the interleaved memory as closer to the processor and non-interleaved memory as far away from the processor is via a static resource affinity table.

6. The method of claim 5 wherein:
the static resource affinity table is configured by a basic input output system (BIOS).

7. An apparatus for optimizing performance of memory in an information handling system comprising:
means for determining whether memory within the information handing system is being accessed in a flexible interleaving memory mode of operation;
means for identifying which of the memory is configured as interleaved memory and which of the memory is configured as non-interleaved memory when the memory is being accessed in the flexible interleaving memory mode of operation; and,
means for configuring the memory such that the interleaved memory is accessed prior to the non-interleaved memory being accessed.

8. The apparatus of claim 7 wherein:
the means for configuring the memory such that the interleaved memory is accessed prior to the non-interleaved memory includes means for accessing a static resource affinity table.

9. The apparatus of claim 7 wherein:
the means for configuring the memory includes means for identifying the interleaved memory as closer to a processor and non-interleaved memory as far away from the processor.

10. The apparatus of claim 9 wherein:
an operating system accesses the memory that is closer to the processor before accessing the memory that is far away from the processor.

11. The apparatus of claim 9 wherein:
the means for identifying the interleaved memory as closer to the processor and non-interleaved memory as far away from the processor is via a static resource affinity table.

12. The apparatus of claim 11 wherein:
the static resource affinity table is configured by a basic input output system (BIOS).

13. An information handling system comprising:
a processor;
memory coupled to the processor;
flexible interleaving memory mode optimization system, the flexible interleaving memory mode optimization system determining whether memory within the information handing system is being accessed in a flexible interleaving memory mode of operation, identifying which of the memory is configured as interleaved memory and which of the memory is configured as non-interleaved memory when the memory is being accessed in the flexible interleaving memory mode of operation; and, configuring the memory such that the interleaved memory is accessed prior to the non-interleaved memory being accessed.

14. The information handling system of claim 13 further comprising:
a static resource affinity table; and wherein,
the configuring the memory such that the interleaved memory is accessed prior to the non-interleaved memory includes accessing a static resource affinity table.

15. The information handling system of claim 13 wherein:
configuring the memory includes identifying the interleaved memory as closer to a processor and non-interleaved memory as far away from the processor.

16. The information handling system of claim 15 further comprising:
an operating system, the operating system accessing the memory that is closer to the processor before accessing the memory that is far away from the processor.

17. The information handling system of claim 15 wherein:
identifying the interleaved memory as closer to the processor and non-interleaved memory as far away from the processor is via a static resource affinity table.

18. The information handling system of claim 17 further comprising:
a basic input output system, the basic input output system configuring the static resource affinity table.
